(19) United States
(12) Patent Application Publication
(10) Pub. No.: US 2018/0052970 A1
(43) Pub. Date: Feb. 22, 2018

(54) TRACKING PATHOGEN EXPOSURE

(71) Applicant: International Business Machines Corporation, Armonk, NY (US)

(72) Inventors: Gregory J. Boss, Saginaw, MI (US); Peter G. Finn, Markham (CA); Rick A. Hamilton, II, Charlottesville, VA (US); James R. Kozloski, New Fairfield, CT (US)

(21) Appl. No.: 15/238,099

(22) Filed: Aug. 16, 2016

(51) Int. Cl. G06F 19/00; G06F 21/60; G06F 21/62; G06F 17/30

(52) U.S. Cl. CPC G06F 19/3431; G06F 21/602; G06Q 2220/00; G06F 17/30312; G06F 19/345; G06F 21/6218

(57) ABSTRACT

Approaches presented herein enable identifying an individual exposed to an illness carried by another individual by securely tracking interactions between individuals and using this information during a public health emergency to alert a public health authority and/or individuals who might be at risk of exposure to an illness. Specifically, a first mobile device of a user detects a second mobile device of another individual via low-energy radio frequency communication. The first device records contact data, including an identification of the second device, a distance between the devices, and a duration that the devices are within a specified distance from one another, and then encrypts and stores this contact data. In response to a public health emergency, the first device conducts an exposure analysis of the stored set of data using distance and duration thresholds to determine if the user came into contact with an individual carrying an illness.

### TECHNICAL FIELD

This invention relates generally to pathogen exposure detection and, more specifically, to tracking a path of pathogen exposure.

### BACKGROUND

Recent years have seen an increasing spread of regional and global diseases, the transmission of which may be facilitated by heightened mobility of the global populace. Ranging from Severe Acute Respiratory Syndrome (SARS) to Middle East Respiratory Syndrome (MERS), from Measles to Avian Influenza and to Ebola and the like, such outbreaks can seize public attention and spur fear from the general public. Further, such outbreaks can consume public resources at evermore demanding rates. Governments and health organizations have increasingly appreciated that stopping a disease's spread in its early stages saves not only lives, but also valuable public resources. Several attempts have been made to improve this field, as described below.

U.S. Patent Application 2015/0100330 discloses: “a method and system for detecting and identifying infectious and hazardous sites” based on “receiving location data from a mobile device associated with a user [and] receiving health data for the user.”

U.S. Pat. No. 7,993,266 discloses: “a personal apparatus” that “transmit[s] proximity data to a computer controller and to each other” where the computer controller “transmit[s] [a] notification to the personal apparatus of [ ] at least one human.”

U.S. Patent Application 2013/0275160 discloses: “[receiving] [l]ocation data . . . for a mobile device and [comparing] a mobility pattern derived from the received location data . . . with a mobility pattern of first users to determine occurrence of a proximity event.”

U.S. Pat. No. 8,405,503 discloses: “[a] contact or proximity network map defin[ing] who and what objects have come in contact of each other including location and time.”

U.S. Patent Application 2016/0026768 discloses: “[a] mobile-enabled health system . . . having a medical device . . . operatively connected to a computing device . . . that operates to receive health care data from a user of the medical device.”

U.S. Patent Application 2014/0273858 discloses: “[b]iometric monitoring devices” that “utilize[e] two different Bluetooth communications interfaces.”

### SUMMARY

In general, embodiments described herein provide for identifying an individual exposed to an illness carried by another individual by securely tracking interactions between individuals and using this information during a public health emergency to alert a public health authority and/or individuals who might be at risk of exposure to an illness. Specifically, a first mobile device of a user detects a second mobile device of another individual via low-energy radio frequency communication. The first device records contact data, including an identification of the second device, a distance between the devices, and a duration that the devices are within a specified distance from one another, and then encrypts and stores this contact data. In response to a public health emergency, the first device conducts an exposure analysis of the stored set of data using distance and duration thresholds to determine if the user came into contact with an individual carrying an illness.

One aspect of the present invention includes a method for identifying an individual exposed to an illness carried by another individual. The method comprises detecting, by a first mobile device, a second mobile device using a low-energy radio frequency communication. The method further comprises recording, encrypting, and storing in a data storage a set of data comprising: an identification number of the second mobile device, a distance between the first mobile device and the second mobile device, and a duration that the second mobile device is within a specified distance to the first mobile device. The method further comprises conducting an exposure analysis of the stored set of data, in response to an identification of an individual carrying an illness, the exposure analysis based on criteria thresholds comprising: a pre-specified distance and a pre-specified duration. This method offers several advantages, such as, but not limited to, using proximity based protocols to anonymously and securely record presence information of mobile devices of other users in close proximity to a user mobile device; and storing this information for extraction and decryption at a time of a health emergency to alert a user who might have been exposed to an illness.

The method of conducting an exposure analysis may optionally further comprise, where a user associated with the first mobile device is the individual carrying the illness, decrypting and searching the set of data to determine if the second mobile device was within the criteria thresholds of the first user device and adding the second user to a list of individuals potentially exposed to the illness in the case that the second mobile device was within the criteria thresholds of the first user device. This, for example, allows the creation of a list of potentially exposed, at-risk contacts based on recorded user device data.

The method may optionally further comprise generating a notification to the second user of a potential exposure to the illness. This offers, for example, an advantage of alerting users who have been potentially exposed to an illness, and permitting a user to alert previous contacts if they were at risk of potential exposure to an illness.

The method may optionally further comprise decrypting a set of data gathered by a mobile device of an individual of the list of individuals potentially exposed to the illness, the set of data comprising: an identification number of a contacted mobile device, a distance between the contacted mobile device and the mobile device of the individual, and a duration that the contacted mobile device is within a specified distance to the mobile device of the individual; and conducting a second exposure analysis of the decrypted set of data of the individual. This technique enables, for example, creating an event tree of related potential medical event exposures to an illness.

The method of conducting an exposure analysis may optionally further comprise receiving a notification comprising an identification number of a mobile device of the individual carrying the illness. The method of conducting an exposure analysis may further comprise decrypting the set of data and determining if the identification number of the mobile device of the individual carrying the illness matches the identification number of the second mobile device and if contact between the first mobile device and the second mobile device is within the criteria thresholds. These techniques permit, for example, a user to determine if he or she came into contact with an individual carrying an illness and whether the contact was at such a proximity and a duration that the user might have been exposed to the illness.

The method may optionally further comprise the set of data being encrypted by a public key, where a corresponding private key is held by an entity authorized to decrypt the set of data in response to the identification of the individual carrying the illness. This technique enables, for example, anonymous and secure storage of a user's contact history, which prevents a malicious third party from accessing the user's history.

The method may optionally further comprise the data store being located in a cloud environment. This technique permits, for example, remote storage of a user's contact history, freeing up storage space on a mobile device of the user.

Another aspect of the present invention includes a computer system for identifying an individual exposed to an illness carried by another individual, the computer system comprising: a memory medium comprising program instructions; a bus coupled to the memory medium; and a processor, for executing the program instructions, coupled to a contact tracking tool via the bus that when executing the program instructions causes the system to: detect, by a first mobile device, a second mobile device using a low-energy radio frequency communication; record a set of data comprising: an identification number of the second mobile device, a distance between the first mobile device and the second mobile device, and a duration that the second mobile device is within a specified distance to the first mobile device; encrypt and store the set of data in a data storage; and in response to an identification of an individual carrying a pathogen, conduct an exposure analysis of the stored set of data, the exposure analysis based on criteria thresholds comprising: a pre-specified distance and a pre-specified duration.

Yet another aspect of the present invention includes a computer program product for identifying an individual exposed to an illness carried by another individual, the computer program product comprising a computer readable storage device, and program instructions stored on the computer readable storage device, to: detect, by a first mobile device, a second mobile device using a low-energy radio frequency communication; record a set of data comprising: an identification number of the second mobile device, a distance between the first mobile device and the second mobile device, and a duration that the second mobile device is within a specified distance to the first mobile device; encrypt and store the set of data in a data storage; and in response to an identification of an individual carrying a pathogen, conduct an exposure analysis of the stored set of data, the exposure analysis based on criteria thresholds comprising: a pre-specified distance and a pre-specified duration.

Yet still another aspect of the present invention includes a method for for identifying an individual exposed to an illness carried by another individual, comprising: providing a computer infrastructure that includes at least one computer device. The computer device operates to perform the steps of detecting, by a first mobile device, a second mobile device using a low-energy radio frequency communication; recording a set of data comprising: an identification number of the second mobile device, a distance between the first mobile device and the second mobile device, and a duration that the second mobile device is within a specified distance to the first mobile device; encrypting and storing the set of data in a data storage; and in response to an identification of an individual carrying a pathogen, conducting an exposure analysis of the stored set of data, the exposure analysis based on criteria thresholds comprising: a pre-specified distance and a pre-specified duration.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture in which the invention may be implemented according to illustrative embodiments;

FIG. 2 shows a user mobile device including a contact tracking application and a contact storage area according to illustrative embodiments;

FIG. 3 shows an exposure analysis process flowchart according to illustrative embodiments;

FIG. 4 shows an illustrative example of collection of user contacts according to illustrative embodiments;

FIG. 5A and FIG. 5B show exposure analysis of contact histories according to illustrative embodiments; and

FIG. 6 shows a process flowchart for determining pathogen exposure risk according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide for identifying an individual exposed to an illness carried by another individual by securely tracking interactions between individuals and using this information during a public health emergency to alert a public health authority and/or individuals who might be at risk of exposure to an illness. Specifically, a first mobile device of a user detects a second mobile device of another individual via low-energy radio frequency communication. The first device records contact data, including an identification of the second device, a distance between the devices, and a duration that the devices are within a specified distance from one another, and then encrypts and stores this contact data. In response to a public health emergency, the first device conducts an exposure analysis of the stored set of data using distance and duration thresholds to determine if the user came into contact with an individual carrying an illness.

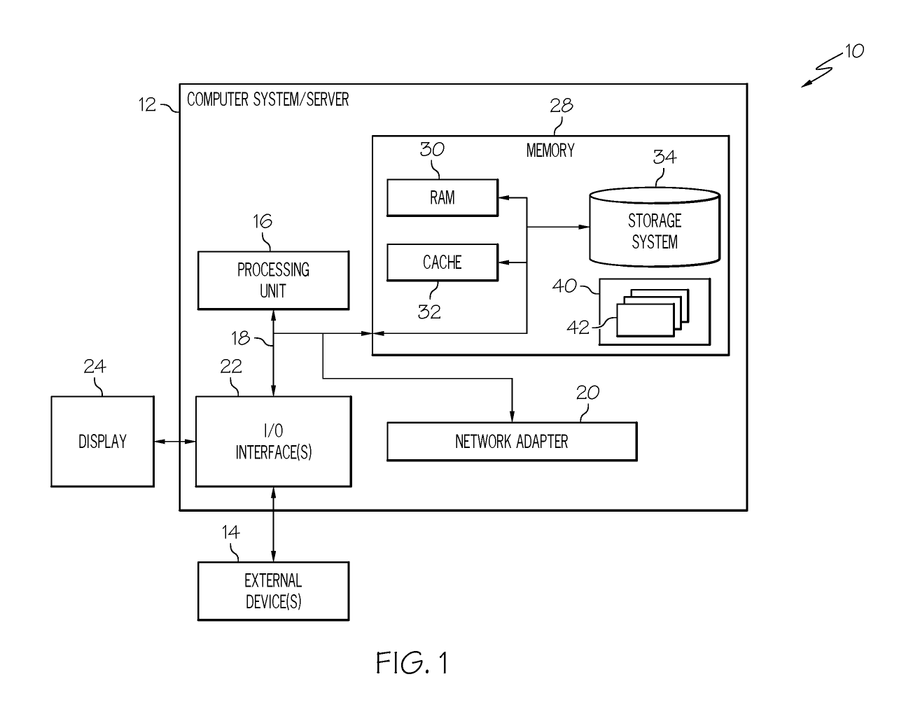

Referring now to FIG. 1, a computerized implementation 10 of an embodiment for retroactively identifying an individual exposed to an illness carried by another individual will be shown and described. Computerized implementation 10 is only one example of a suitable implementation and is not intended to suggest any limitation as to the scope of use or functionality of embodiments of the invention described herein. Regardless, computerized implementation 10 is capable of being implemented and/or performing any of the functionality set forth hereinabove.

In computerized implementation 10, there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

This is intended to demonstrate, among other things, that the present invention could be implemented within a network environment (e.g., the Internet, a wide area network (WAN), a local area network (LAN), a virtual private network (VPN), etc.), a cloud computing environment, a cellular network, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer system 12 is intended to demonstrate that some or all of the components of implementation 10 could be deployed, managed, serviced, etc., by a service provider who offers to implement, deploy, and/or perform the functions of the present invention for others.

Computer system 12 is intended to represent any type of computer system that may be implemented in deploying/realizing the teachings recited herein. Computer system 12 may be described in the general context of computer system executable instructions, such as program modules, being executed by a computer system. Generally, program modules may include routines, programs, objects, components, logic, data structures, and so on, that perform particular tasks or implement particular abstract data types. In this particular example, computer system 12 represents an illustrative system for retroactively identifying an individual exposed to an illness carried by another individual. It should be understood that any other computers implemented under the present invention may have different components/software, but can perform similar functions.

Computer system 12 in computerized implementation 10 is shown in the form of a general-purpose computing device. The components of computer system 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for retroactively identifying an individual exposed to an illness carried by another individual, which is stored in memory 28, storage system 34, and/or program/utility 40. While executing computer program code, processing unit 16 can read and/or write data to/from memory 28, storage system 34, and program/utility 40.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The inventors of the present invention have discovered several limitations of current methods of monitoring and determining pathogen exposure. While recent years have seen an increasing spread of regional and global diseases (e.g., SARS, MERS, Measles, Avian Influenza, Ebola, and the like), the transmission of which may be facilitated by a heightened mobility of the global populace, efforts to find potentially exposed contacts of a person carrying a pathogen (e.g., a bacterium, virus, or other microorganism that can cause disease), other hazardous condition (e.g., radiation contamination), or who has been exposed to another cause of illness (e.g., food poisoning) during such an epidemic remain unreliable. Although governments and health organizations have increasingly appreciated that stopping the spread of a disease early is necessary to save lives, as well as valuable public resources, early location of persons exposed in a population is inexact and non-comprehensive.

Current methods of determining who may be at risk of exposure are often dependent on often unreliable factors, including: (a) self-reporting by a patient, (b) reporting of possible contact by bystanders, and/or (c) third-party reporting. Self-reporting relies upon a patient, often suffering debilitating effects from a disease, recalling who he or she may have been in contact with during a specified contagious period. Bystander reporting involves a public declaration that someone has been diagnosed with a disease, and members of the public recognizing this person and coming forward to say that they have had contact with him or her. Third-party reporting usually hinges on an authoritative figure recognizing that two people have been in contact. For instance, a teacher might identify minors who have been in proximity, or a supervisor might consult staffing assignments to determine who may have worked together on a given shift.

Each of these approaches, however, leaves gaps and may result in incorrect information. For instance, with patient self-reporting, the patient may not have a perfect memory of contacts, particularly if he or she is suffering adverse effects from an illness. Bystander and third-party reporting can permit even more room for missed contacts, because these forms of reporting depend on being able to alert potentially affected parties or those familiar with the potentially affected, and then relying on their recollection. In other words, a potentially exposed individual must be informed of a diagnosis of a particular individual and, further, accurately remember interactions with the particular individual. As a result, errors may occur and potentially exposed individuals can be missed.

The approaches described herein contain numerous advantages over present methods including, but not limited to, the creation of a list of potentially exposed, at-risk contacts based on recorded user device data. Approaches further include alerting users who have been potentially exposed and are at risk, and permitting a user to alert previous contacts if they were potentially exposed and are at risk. More specifically, presented here are approaches for using proximity based protocols (e.g., Bluetooth Low Energy (BLE), Near Field Communication (NFC), etc.) to anonymously and securely record presence information or data of mobile devices of other users in close proximity to a user mobile device, while maintaining the privacy of the users. Approaches further include storing that information (e.g., in a cloud-based service) and extracting and decrypting this information at a time to alert either health officials and/or a user who might have been exposed by generating a medical event block tree using the information and performing a “back trace” analysis of the medical event block tree to find potential medical event exposures.

It should be understood that embodiments of the present invention capitalize on advances in both sociological and technological areas. For example, embodiments of the present invention make use of the prevalence of users carrying a mobile device, such as a smart phone and other wearable device, which has reached a saturation point in recent years. Furthermore, the recent rise of low energy radio frequency (low-energy RF) technologies, including BLE, NFC, and associated RF capabilities facilitate operation of embodiments of the present invention. Moreover, embodiments of the present invention avail themselves of epidemiology and related mathematical modeling, as well as computational advances permitting “big data” analytics. The following discussion of embodiments of the present invention will reference applicable uses of technology in these areas. However, features and techniques of these areas will not be discussed in detail in order to avoid unnecessarily obscuring the presented embodiments.

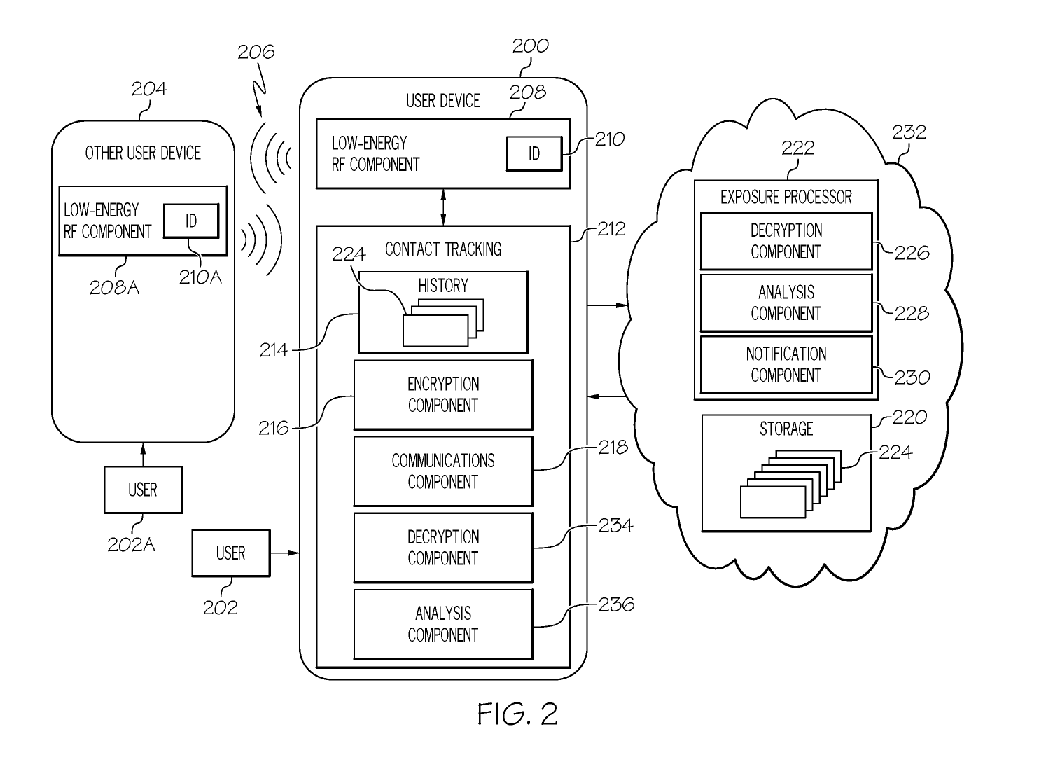

Referring now to FIG. 2, user mobile device 200 of user 202 for recording low energy radio frequency activity 206 from another user mobile device 204 of another user 202A, located near user device 200, is shown. User device 200 and other user device 204 can include, but are not limited to, a mobile phone, a smart phone, any other mobile device, a personal electronic (e.g., a personal digital assistant (PDA)), a wearable (e.g., a wrist wearable, such as a smart watch, smart glasses), etc.

User device 200 contains low-energy RF component 208, which, in some embodiments, can comprise Near Field Communication (NFC) or Bluetooth Low Energy (BLE) technology or any other analogous low-energy radio frequency technology. Low-energy RF component 208 can include a device identification or low-energy RF component identification 210. Identification 210 can be a unique identifier associated with user device 200 and can be registered with exposure processor/system 222 so that exposure processor 222 can identify user device 200. The other user device 204 can also contain a low-energy RF component 208A and identification 210A associated with the other user device 204.

Low-energy RF component 208 of user device 200 can be used to detect the presence of another user device 204 near user device 200 by detecting low-energy RF component 208A of the other user device 204. In one example, this may be accomplished by low-energy RF component 208 sending out a communication of low energy radio frequency activity 206 and receiving in response a communication of low energy radio frequency activity 206 containing identification 210A from low-energy RF component 208A. Accordingly, when user 202 and other users 202A wear or keep a user device close to their person, low-energy RF component 208 of user device 200 can detect the presence of other users near user 202 by detecting low-energy RF component 208A of other user devices 204. Low-energy RF component 208 can further be configured to constantly or periodically monitor for other user devices 204. For example, low-energy RF component 208 may periodically poll for nearby other user devices 204 at a predetermined interval, such as once a second, once every five seconds, etc.

User device 200 can further include a content tracking application and/or program instructions 212 that configure user device 200 to carry out contact tracking operations of embodiments of the present invention as described herein. In some embodiments, application 212 can be program/utility 40 (FIG. 1), having a set of components or program modules 42 (FIG. 1) for carrying out these operations of embodiments of the invention.

When low-energy RF component 208 detects low-energy RF component 208A of other user device 204 and receives identification 210A or other tokenized information of other user device 204, encryption component 216 can encrypt or anonymize identification 210A of other user device 204 and any associated data. This, for example, protects an identification of other user 202A and other user device 204.

Further, when low-energy RF component 208 detects low-energy RF component 208A of another user device 204 and receives identification 210A of that other user device 204, content tracking application 212 can store the contact in history storage 214 as contact record 224. Contact record 224 can contain a set of data associated with the contact, including, but not limited to: anonymized identification numbers associated with other user devices 204; approximate distance between user device 200 and other user device 204 (e.g., approximated according to signal strength, time required for poll-and-response handshake, etc.); and approximate exposure duration (e.g., determined by number of polling cycles, number of positive monitor responses achieved, etc.). Contact record 224 can optionally further contain location data (e.g., derived from a Global Positioning System (GPS)) or other metadata (e.g., to facilitate accurate decoding of the recorded data).

In some embodiments, user 202 may choose to record only his or her movements, for example by GPS. Accordingly, in some embodiments, contact records 224 can alternatively contain a list of location data associated with user 202.

In an embodiment, periodically (e.g., hourly, daily, upon arrival by the user at a location that has wi-fi), device 200 can upload contact records 224 to storage 220. In some embodiments, storage 220 can be embodied as a remote storage location in a cloud environment 232. In still other embodiments, storage 220 may be local storage, such as on a user device or a user server, or a remote server or storage system. Contact records 224 can be stored on storage 220 as encrypted files, files with encrypted identifiers, or any other type of anonymize data files. Periodically transferring contact records 224 to storage 220 frees space on user device 200, and may permit simplified gathering of contact information for analysis should a health emergency be declared.

User device 200 and storage 220 can, in some embodiments, be in contact with an exposure processor 222 or other central system for carrying out some operations of embodiments of the present invention. In one embodiment, exposure processor 222 can reside in cloud environment 232. Exposure processor 222 can perform tasks, including, but not limited to, coordinating storage of contact records 224, determining if an individual has been potentially exposed to a pathogen based on contact records 224, and notifying user 202 in the event of an exposure event.

In some embodiments, exposure processor 222 and storage 220 in cloud environment 232 can be part of a distributed database, such as a blockchain database (e.g., an IBM blockchain service). A blockchain operates by creating permanent, public ledgers of all transactions within a network. A blockchain is made of data structure blocks, which can hold data and/or program instructions, with each block holding batches of individual transactions and the results of any blockchain executables. Each block contains a timestamp and information linking it to a previous block. Accordingly, in some embodiments, device 200 can upload contact records 224 to a block serving as storage 220. Further, contact records 224 can be processed and analyzed, as will be descried further below, by a program for a processor 222 residing in a block of the blockchain.

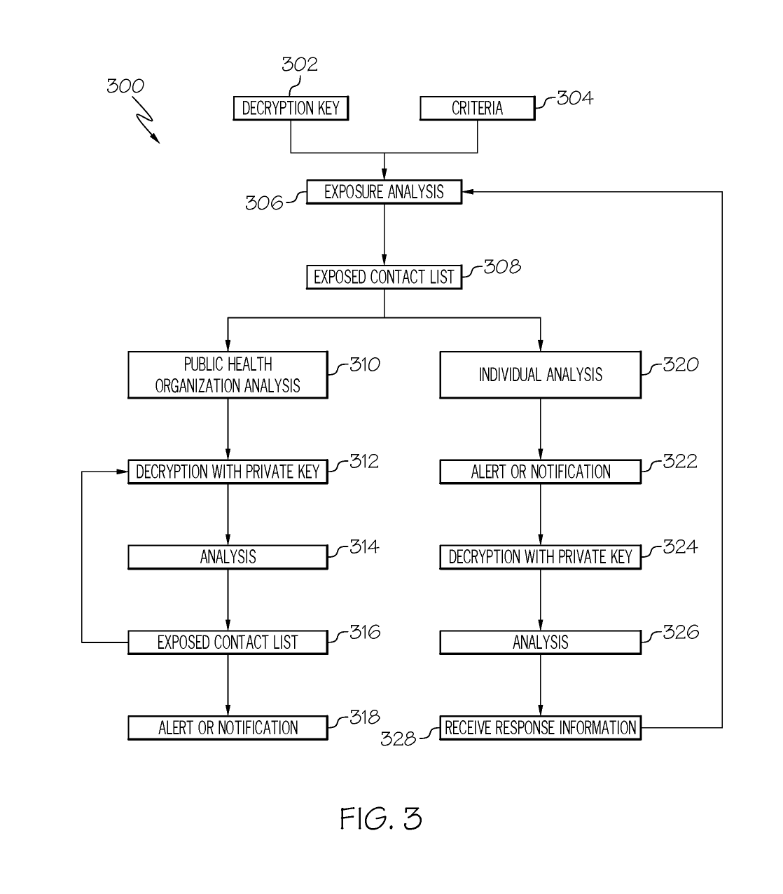

Referring now to FIG. 3, in association with FIG. 2, approaches 300 for conducting an exposure analysis in response to a contagion announcement will be discussed. A health official or public health authority, such as the Center for Disease Control (CDC), may determine that it has identified a person carrying or suffering from a pathogen, other hazardous condition (e.g., radiation contamination), or who has been exposed to another cause of illness (e.g., food poisoning) (hereinafter, “a person carrying a pathogen”). Following this determination, the exposure processor 222 of the present invention can be used to conduct an exposure analysis and/or to notify other users who may have been exposed to the pathogen or communicable disease by the person carrying the pathogen.

Exposure processor 222 can initiate an exposure analysis 306 at analysis component 228 after receiving an instruction. In an embodiment, this instruction can include a decryption key 302, from a public health authority and/or the person carrying the pathogen to decode contact records 224 associated with the person carrying the pathogen. Decryption component 226 in exposure processor 222 can apply decryption key 302 to contact records 224 of the person carrying the pathogen. From the decrypted contact records 224, exposure processor 222 conducts exposure analysis 306 to construct a potentially exposed contact list 308 backwards through time, indicating each low-energy RF identifier or other contact number/identifier with which a mobile device of the person carrying the pathogen came into contact.

The public health authority or a medical professional may provide a set of thresholds, protocols, or criteria 304 to isolate which contacts in the contact list are most likely at risk for exposure. For example, a physician may provide risk zone criteria, such as a minimum time that a person would need to be exposed to the person carrying the pathogen, a maximum distance from the person carrying the pathogen that a person would need to be within in order to be at risk, and/or the like. These time and distance thresholds can, in some embodiments, be on a sliding scale. For example, for a given pathogen, there may be a possibility of exposure after only ten minutes at four feet or less from a person carrying the pathogen, while a person between four and ten feet has a risk of exposure only after 30 minutes. A physician could also provide other criteria, such as an incubation time period, an infections time period, and/or a maximum time period after a person carrying a pathogen has left a location during which a person might still come into contact with a pathogen from the person carrying the pathogen (e.g., a time a pathogen remains active on a surface touched by the person carrying the pathogen). Any identifier or contact number that exposure analysis 306 flags as having been in contact with the person carrying the pathogen and that falls within the contact criteria can be flagged and placed on an exposure risk contact list 308.

Notification component 230 can use each low-energy RF identifier or other contact number/identifier on the exposure risk contact list 308 to identify other users 202 who are at risk for potential exposure. Notification component 230 can then notify the other users 202 of their at-risk status and prompt further decryption of contact records 224 of the other users in order to permit further exposure analyses. Approaches to further exposure analyses will be discussed in more detail below.

In public health authority exposure analysis 310, a public health authority (e.g., the CDC) can decrypt some or all contact records 224 with a set of private keys held by the public health authority. In the event of an epidemic contagion, the public health authority can use contact records 224 of the person carrying the pathogen to recreate a digital trail of that in order to determine other persons with whom the person carrying the pathogen has been in contact, and then with whom those persons have been in contact, and so on.

One advantage of analysis by a public health authority is that it permits for a centralized, fast, and early response to a growing epidemic. This allows the public health authority to quickly find individuals who may have been exposed to a pathogen or other communicable disease and offer them medical attention. A quick response and treatment of affected individuals is generally understood to be the best way to prevent or curb the spread of an epidemic. It should be understood that in embodiments of the present invention, a public health authority analysis would be used only when a contagion has been detected, and only to identify parties who have had contact with the person carrying the contagion.

To accomplish this, the public health authority instructs decryption component 226 to decrypt and analysis component 228 to analyze contact records 224 of the person carrying the pathogen in order to create an exposure contact list, as described above. The public health authority can then instruct decryption component 226 of exposure processor 222 to conduct a secondary decryption 312 of secondary contact records 224 of users identified as at risk in exposure contact list 308. Analysis component 228 of processor 222 can then, for example using medical criteria such as distances, exposure times, incubation periods, and/or other risk factors, conduct a secondary analysis 314 of these secondary decrypted contact records 224 to create a secondary at-risk contact list 316. This process can be repeated (e.g., tertiary analysis, quaternary analysis, etc.) to construct an increasingly comprehensive medical event block tree of contacts at risk of pathogen exposure.

Moreover, contact records 224 of a person exposed to the person carrying the pathogen can be used to determine additional persons who may have been in the vicinity of exposure. For example, if exposure analysis 306 determines that user 202 had contact with the person carrying the pathogen at a specific time and place, then contact records 224 of user 202 can be analyzed for contact with other user devices 204 of other users 202A at the same time and place, indicating that those other users 202A may also have been exposed.

Furthermore, as contacts at risk of pathogen exposure are discovered, notification component 230 of exposure processor 222 can send notifications 318 to the at-risk contacts or post alerts (e.g., to a webpage or mobile device application) for them to view. In order to send a notification, an identity of an at-risk contact can be retrieved from a registration record (e.g., created when user 202 adds contact tracking application 212 to user device 200), which links user 202 to identification 210 of user device 200. This notification 318 can comprise information such as a warning that user 202 may have been exposed to a pathogen, a time or place of the possible exposure, and/or recommendations for how to respond to the possible exposure, including, for example, going to a hospital or doctor's office for a checkup or staying at home and limiting contact with others.

On the other hand, in individual exposure analysis 320, user 202 holds a public encryption key and a private encryption key that are specific to that individual. When low-energy RF component 208 detects the low-energy RF component 208A of another user device 204 and receives identification 210A of the other user device 204, encryption component 216 can encrypt the received information using the public encryption key of user 202. In this embodiment, only user 202 has the means to decrypt and view his or her contact history.

The advantage of self-investigative individual analysis is that it maintains data privacy, while providing motivated individuals with a notification mechanism. In this embodiment, users maintain control over their data. A public health authority, government, or third-party agent cannot decipher personally-identifiable contact information, thereby preventing malicious actors from making unauthorized inquiries into a person's interaction with other individuals.

In individual exposure analysis 320, in the event of a contagious epidemic, exposure processor 222 can issue an announcement with information about the contagion, including a device identifier associated with an exposure risk (e.g., a person carrying a pathogen) and minimum criteria required to be at risk of exposure. The announcement could further include a request that users decrypt their contact histories to check if they came into contact with any of the device identifiers listed in the announcement as exposure risks.

In some embodiments, contact tracking application 212 of user device 200 can periodically (e.g., hourly, daily) check for an exposure alert 322 on exposure processor 222. In another embodiment, after an exposure event has occurred, exposure processor 222 can send out the alert 322 as a notification (e.g., an email, a text message, an in-application alert, etc.), to a set of users 202 and request that each user 202 check his or her contact history for the identifiers listed as exposure risks.

User 202 can check his or her contact history by using decryption component 234 of contact tracking application 212 and his or her private key to decrypt contact records 224, as shown at 324. The private key of user 202 may be stored in decryption component 234. Contact tracking application 212 can then analyze the decrypted contact records, as shown at 326, using analysis component 236 of contact tracking application 212. This analysis can include searching the decrypted contact records for a device identifier matching a device identifier of a person carrying a pathogen indicated by alert 322 and determining if the contact with the indicated identifier was sufficient to place user 202 at risk of exposure under the criteria. In some embodiments, the analysis can alternatively include searching the decrypted contact records for a time and location matching a time and location of a person carrying a pathogen indicated by alert 322.

In the event that analysis component 236 finds that user 202 came into contact with the device identifier of the person carrying the pathogen indicated by alert 322 and is therefore at risk of having been exposed, contact tracking application 212 can present user 202 with further information based on alert 322. This information can comprise, for example, a warning that user 202 may have been exposed to a pathogen; a time or place of the possible exposure; recommendations for how to respond to the possible exposure, including, for example, going to a hospital or doctor's office for a checkup or staying at home and limiting contact with others; and/or options to report the possible exposure, including volunteering to report the user's identity and device identifier to a public health authority or other public health official, such as the CDC, or choosing to receive further information, but not disclosing the user's identity, etc.

In some embodiments, a combination of both public health organization exposure analysis 310 and individual exposure analysis 320 can be used. For example, some users may configure a security setting of contact tracking application 212 to prevent public health authority decryption of the users' contact records, while other users may configure the security setting to allow public health authority decryption of the users' contact records. Accordingly, in some embodiments, a public health authority reviews and analyzes only records the public health authority has permission to access, while posting general alerts for the benefit of any users who have opted not to share their contact records.

In still other embodiments, only individual decryption and analysis may be used. In another embodiment, individual decryption and analysis may be used to initiate building a medical event block tree. For example, a person carrying a pathogen may not have contact tracking application 212 on his or her mobile device. In this case, a public health authority can instruct exposure processor 222 to generate alert 322 and issue the alert as an announcement with information about a contagious pathogen, including a device identifier associated with the person carrying the pathogen and minimum criteria required to be considered at risk of exposure. The announcement could further include a request that users decrypt their contact histories to check if they came into contact with a device identifier listed in the announcement and, if so, to share his or her information with the public health authority to contribute to a medical event block tree.

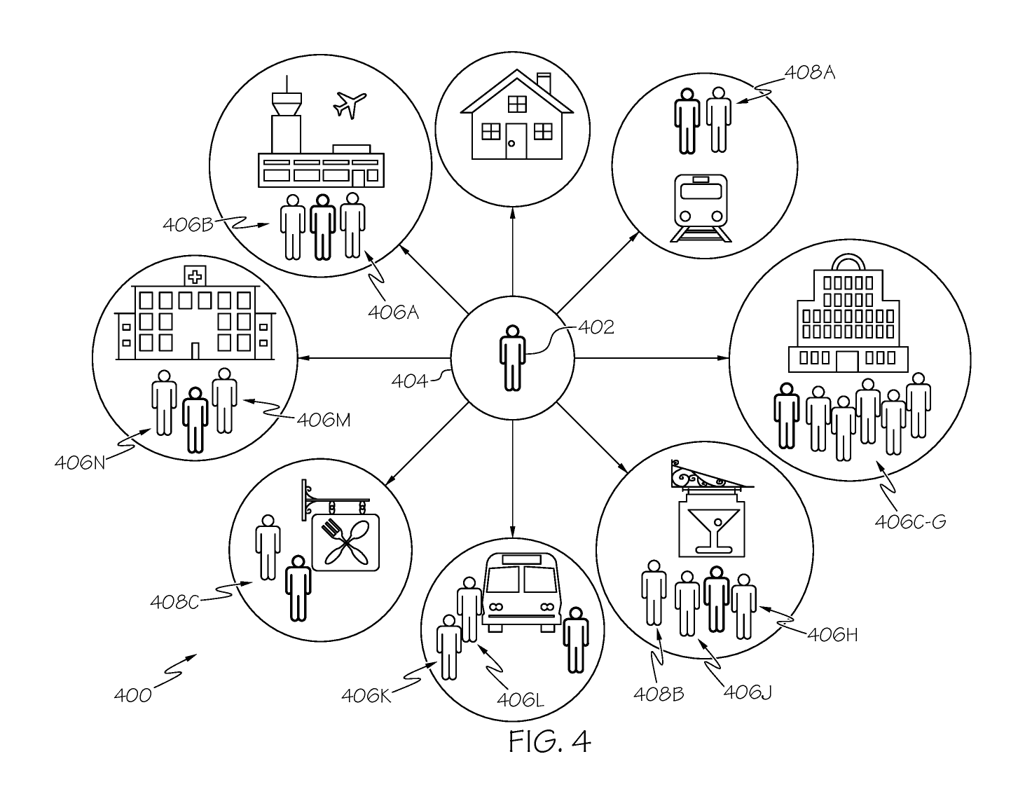

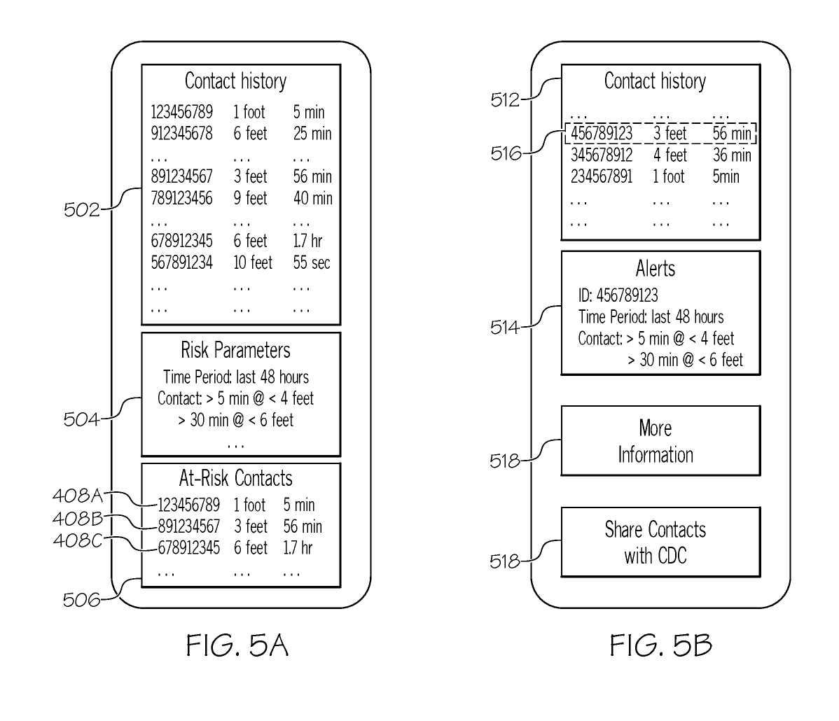

Referring now to FIG. 4 and FIGS. 5A and 5B, an illustrative example of user contacts collection and exposure analysis according to illustrative embodiments is shown. Referring first to FIG. 4, user 402, “Rick”, returns from a business trip in the Kingdom of Saudi Arabia, flying from Jeddah, SA to New York, N.Y. On the plane, he is seated between persons 406A and 406B. Rick feels well during the 13 hour flight, but weary after he goes home, a condition he attributes to jet lag. The next morning, Rick feels slightly feverish, but continues to attribute this to the effects of international travel. He takes the subway to his Manhattan office, standing for five minutes next to user 408A, “Greg”, who Rick has sometimes seen on the subway, but does not personally know, and attends a full day of meetings with coworkers, where he shakes the hands of five coworkers 406C-G. After work, Rick walks to a crowded bar with two friends 406H and 406J, where he stands for almost an hour within three feet of user 408B, “Peter,” a person unknown to Rick. Rick then takes a bus, on which he is seated about nine feet away from persons 406K and 406L for about 40 minutes to a restaurant in Brooklyn, where he and user 408C, “James,” a person unknown to Rick, are within six feet of each other for almost two hours, having been seated at tables next to each other at approximately the same time. After dinner, Rick walks back to his apartment.

On his second day after returning to New York, Rick's symptoms are worse; he has trouble getting out of bed, his fever is high, and he has shortness of breath. He calls 911 for an ambulance to take him to the hospital, where he is seen by nurse 406M for five minutes and doctor 406N for 45 minutes. After reviewing Rick's symptoms and recent travel, the doctor determines that Middle East Respiratory Syndrome (MERS) is the primary possible cause of his illness. This diagnosis raises the attention of the CDC and other public health officials.

The doctor further estimates that Rick has likely been contagious for the past 48 hours and that anyone who has been within four feet of Rick for five minutes or more and within six feet for 30 minutes or more was within exposure risk zone 404 and is at risk of infection. At this point, Rick is exhausted and has trouble remembering everyone he has been in contact with in the past days. Rick's manager helps identify coworkers 406C-G as being in a meeting in a conference room with Rick, and Rick can remember having drinks with friends 406H and 406J, and the hospital knows that medical professionals 406M and 406N attended to Rick. Yet, Rick and health officials are unable to identify anyone else with whom Rick has had contact.

However, Rick's mobile phone, on which contact tracking application 212 is installed, has continuously recorded low-energy radio frequencies that the mobile phone has come into contact with, using signal strength as an indicator of distance and duration of signal as an indicator of duration of contact. Rick's mobile phone has uploaded these records, as encrypted files, to a storage cloud. The CDC receives Rick's permission to access his records, and, using Rick's decryption key, views Rick's contact history 502, shown in FIG. 5A. The CDC may enter risk parameters 504 determined by Rick's doctor to narrow Rick's contact history to a list of at-risk contacts 506.

From Rick's contact history, the CDC determines that Rick came into contact with several persons 408A-C who, therefore, might have been exposed. Persons 408A-C are added to a medical event block tree. User 408A, Greg, has contact tracking application 212 installed on his smart watch. Greg previously configured contact tracking application 212 to share his contact history with a requesting public health authority in the event of an epidemic. Accordingly, the CDC can contact Greg, warning him that he may have been exposed and advising him to go to a hospital for a checkup. The CDC can further decrypt Greg's contact history and determine if, subsequent to Greg's contact with Rick, Greg had contact, within the exposure risk parameters, with anyone else by performing a secondary exposure analysis on Greg's contacts to generate a secondary at-risk contact list to add to the medical event block tree.

User 408B, Peter, who also has contact tracking application 212 installed on his smart phone, has configured his application to not share his contact history 512, as shown in FIG. 5B, with a requesting public health authority in the event of an epidemic. In order to reach users like Peter, the CDC issues an alert 514, indicating Rick's contact identification, exposure window, and exposure parameters. The contact tracking application 212 on Peter's smart phone checks for alerts, discovers alert 514 issued by the CDC, and checks Peter's contact history for any matching identifications 516 having a time, duration, and distance within the exposure parameters. The contact tracking application 212 then notifies Peter that he may have been exposed and provides him with options 518 to view more information and/or share his contact exposure information with the CDC.

Accordingly, using embodiments of the present invention, a public health organization can quickly find and alert individuals who may have been exposed to a contagion, but who would have been missed as unknown contacts under traditional manners of assembling potential exposure lists.

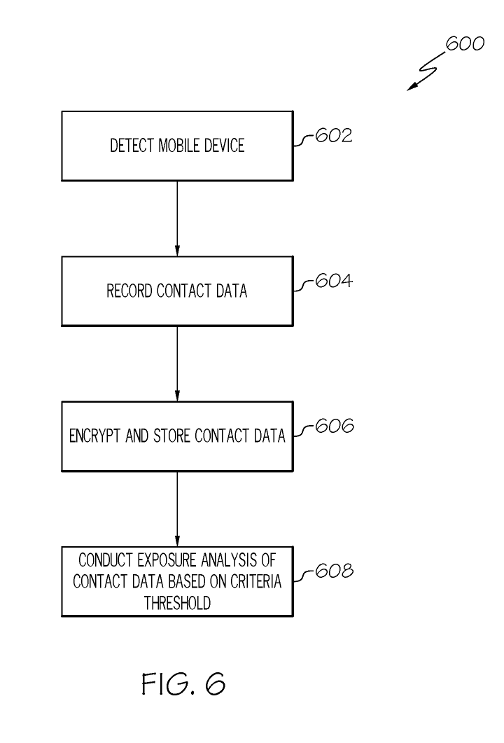

As depicted in FIG. 6, in one embodiment, a system (e.g., computer system 12) carries out the methodologies disclosed herein. Shown is a process flowchart 600 for retroactively identifying an individual exposed to an illness carried by another individual. At step 602, mobile device 200 detects second mobile device 204. At step 604, mobile device 200 records a set of contact data, which includes identification number 210A of second mobile device 204, a distance between first mobile device 200 and second mobile device 204, and a duration that the second mobile device 204 is within a specified distance to first mobile device 200. At step 606, mobile device 200 encrypts and stores the set of contact data in data storage 214. At step 608, in response to an identification of an individual carrying an illness, mobile device 200 conducts an exposure analysis of the stored set of data, the exposure analysis based on criteria thresholds including a distance and a duration.

Process flowchart 600 of FIG. 6 illustrates the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for retroactively identifying an individual exposed to an illness carried by another individual. Thus, embodiments herein disclose a process for supporting computer infrastructure, comprising integrating, hosting, maintaining, and deploying computer-readable code into a computing system (e.g., computer system 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for retroactively identifying an individual exposed to an illness carried by another individual. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device, such as a hardware storage device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is apparent that there has been provided herein approaches to retroactively identifying an individual exposed to an illness carried by another individual. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for identifying an individual exposed to an illness carried by another individual, the method comprising:
detecting, by a first mobile device, a second mobile device using a low-energy radio frequency communication;
recording a set of data comprising: an identification number of the second mobile device, a distance between the first mobile device and the second mobile device, and a duration that the second mobile device is within a specified distance to the first mobile device;
encrypting and storing the set of data in a data storage; and
in response to an identification of an individual carrying an illness, conducting an exposure analysis of the stored set of data, the exposure analysis based on criteria thresholds comprising: a pre-specified distance and a pre-specified duration.

2. The method of claim 1, wherein a user associated with the first mobile device is the individual carrying the illness, the conducting an exposure analysis comprising:
decrypting the set of data;
searching the set of data to determine if the second mobile device was within the criteria thresholds of the first user device; and
adding the second user to a list of individuals potentially exposed to the illness in the case that the second mobile device was within the criteria thresholds of the first user device.

3. The method of claim 2, the method further comprising generating a notification to the second user of a potential exposure to the illness.

4. The method of claim 2, the method further comprising:
decrypting a set of data gathered by a mobile device of the second user on the list of individuals potentially exposed to the illness, the set of data comprising: an identification number of a contacted mobile device, a distance between the contacted mobile device and the mobile device of the second user, and a duration that the contacted mobile device is within a specified distance to the mobile device of the second user; and
conducting a second exposure analysis of the decrypted set of data of the second user.

5. The method of claim 4, the second exposure analysis comprising:
examining the decrypted set of data of the second user based on criteria thresholds comprising: a distance, a duration, and an incubation time;
determining if a third mobile device was within the criteria thresholds of the mobile device of the second user; and
notifying the third user based on the examination.

6. The method of claim 1, the conducting an exposure analysis comprising:
receiving a notification comprising an identification number of a mobile device of the individual carrying the illness;
decrypting the set of data; and
determining if the identification number of the mobile device of the individual carrying the illness matches the identification number of the second mobile device and if contact between the first mobile device and the second mobile device is within the criteria thresholds.

7. The method of claim 1, wherein the set of data is encrypted by a public key, and wherein a corresponding private key is held by an entity authorized to decrypt the set of data in response to the identification of the individual carrying the illness.

8. The method of claim 1, wherein the data store is located in a cloud environment.

9. A computer system for identifying an individual exposed to an illness carried by another individual, the computer system comprising:
a memory medium comprising program instructions;
a bus coupled to the memory medium; and
a processor, for executing the program instructions, coupled to a contact tracking tool via the bus that when executing the program instructions causes the system to:
detect, by a first mobile device, a second mobile device using a low-energy radio frequency communication;
record a set of data comprising: an identification number of the second mobile device, a distance between the first mobile device and the second mobile device, and a duration that the second mobile device is within a specified distance to the first mobile device;
encrypt and store the set of data in a data storage; and
in response to an identification of an individual carrying an illness, conduct an exposure analysis of the stored set of data, the exposure analysis based on criteria thresholds comprising: a pre-specified distance and a pre-specified duration.

10. The computer system of claim 9, wherein a user associated with the first mobile device is the individual carrying the illness, the instructions further causing the system to:
decrypt the set of data;
search the set of data to determine if the second mobile device was within the criteria thresholds of the first user device; and
add the second user to a list of individuals potentially exposed to the illness in the case that the second mobile device was within the criteria thresholds of the first user device.

11. The computer system of claim 10, the instructions further causing the system to generate a notification to the second user of a potential exposure to the illness.

12. The computer system of claim 10, the instructions further causing the system to:
decrypt a set of data gathered by a mobile device of the second user on the list of individuals potentially exposed to the illness, the set of data comprising: an identification number of a contacted mobile device, a distance between the contacted mobile device and the mobile device of the second user, and a duration that the contacted mobile device is within a specified distance to the mobile device of the second user; and
conduct a second exposure analysis of the decrypted set of data of the second user.

13. The computer system of claim 12, the instructions further causing the system to:
examine the decrypted set of data of the second user based on criteria thresholds comprising: a distance, a duration, and an incubation time;
determine if a third mobile device was within the criteria thresholds of the mobile device of the second user; and
notify the third user based on the examination.

14. The computer system of claim 9, the instructions further causing the system to:
receive a notification comprising an identification number of a mobile device of the individual carrying the illness;
decrypt the set of data; and
determine if the identification number of the mobile device of the individual carrying the illness matches the identification number of the second mobile device and if contact between the first mobile device and the second mobile device is within the criteria thresholds.

15. The computer system of claim 9, wherein the set of data is encrypted by a public key, and wherein a corresponding private key is held by an entity authorized to decrypt the set of data in response to the identification of the individual carrying the illness.

16. A computer program product for identifying an individual exposed to an illness carried by another individual, the computer program product comprising a computer readable storage device, and program instructions stored on the computer readable storage device, to:
detect, by a first mobile device, a second mobile device using a low-energy radio frequency communication;
record a set of data comprising: an identification number of the second mobile device, a distance between the first mobile device and the second mobile device, and a duration that the second mobile device is within a specified distance to the first mobile device;
encrypt and store the set of data in a data storage; and
in response to an identification of an individual carrying an illness, conduct an exposure analysis of the stored set of data, the exposure analysis based on criteria thresholds comprising: a pre-specified distance and a pre-specified duration.

17. The computer program product of claim 16, wherein a user associated with the first mobile device is the individual carrying the illness, the computer readable storage device further comprising instructions to:
decrypt the set of data;
search the set of data to determine if the second mobile device was within the criteria thresholds of the first user device; and
add the second user to a list of individuals potentially exposed to the illness in the case that the second mobile device was within the criteria thresholds of the first user device.

18. The computer program product of claim 17, the computer readable storage device further comprising instructions to generate a notification to the second user of a potential exposure to the illness.

19. The computer program product of claim 17, the computer readable storage device further comprising instructions to:
decrypt a set of data gathered by a mobile device of the second user on the list of individuals potentially exposed to the illness, the set of data comprising: an identification number of a contacted mobile device, a distance between the contacted mobile device and the mobile device of the second user, and a duration that the contacted mobile device is within a specified distance to the mobile device of the second user;
conduct a second exposure analysis of the decrypted set of data of the second user;
examine the decrypted set of data of the second user based on criteria thresholds comprising: a distance, a duration, and an incubation time;
determine if a third mobile device was within the criteria thresholds of the mobile device of the second user; and
notify the third user based on the examination.

20. The computer program product of claim 16, the computer readable storage device further comprising instructions to:
receive a notification comprising an identification number of a mobile device of the individual carrying the illness;
decrypt the set of data; and
determine if the identification number of the mobile device of the individual carrying the illness matches the identification number of the second mobile device and if contact between the first mobile device and the second mobile device is within the criteria thresholds.
